(19) United States
(12) Patent Application Publication
(10) Pub. No.: US 2026/0001353 A1
(43) Pub. Date: Jan. 1, 2026

(54) RECORDING APPARATUS, RECORDING METHOD, AND STORAGE MEDIUM

(71) Applicant: CANON KABUSHIKI KAISHA, Tokyo (JP)

(72) Inventors: HIROSHI KAWAFUJI, Tokyo (JP); NAOKO BABA, Kanagawa (JP); TAKUMI OTANI, Kanagawa (JP); AKIHIRO MOURI, Tokyo (JP); RYOSUKE HIROKAWA, Meerbusch (DE); YUKI MORITA, Tokyo (JP)

(21) Appl. No.: 19/249,087

(22) Filed: Jun. 25, 2025

(30) Foreign Application Priority Data
Jun. 28, 2024 (JP) 2024-105403

(51) Int. Cl. B41J 11/00; B41J 2/045; B41J 13/00; B41J 25/00

(52) U.S. Cl. CPC B41J 11/0025; B41J 2/04573; B41J 11/002; B41J 11/0095; B41J 13/0036; B41J 25/001; B41J 2/04586

(57) ABSTRACT

A recording apparatus includes a recording unit configured to, in response to an instruction to record an image, apply a recording agent while performing a scan in a scan direction that intersects with a conveyance direction in which a recording medium is conveyed to record an image on the recording medium, a conveyance unit configured to convey the recording medium, a plurality of paper discharge units to which the recording medium is to be discharged, and a control unit configured to control, based on a width of recording data in the scan direction and recording scan speed of a recording scan, the recording unit to perform the scan so that time since start of the recording scan until start of a next recording scan becomes a predetermined value.

### BACKGROUND

### Field of the Disclosure

The present disclosure relates to a recording apparatus and a recording method.

### Description of the Related Art

An ink-jet recording apparatus has been known as one of recording apparatuses, and aqueous liquid ink is used as a recording agent in many ink-jet recording apparatuses. Liquid ink requires fixing time to permeate into a recording medium and dry. However, when sufficient fixing time is not ensured, an ink smudge called a “smear” is caused on a recording surface (surface on which an image is recorded), a back surface of the recording surface, or the like due to ink that has failed to be fixed.

To prevent such an issue, Japanese Patent Application Laid-Open No. 2022-65753 discusses a technique of controlling, based on an amount of ink applied onto a recording medium on which an image has been previously recorded and a width of the recording medium, delay time (waiting) of a recording operation until a subsequent recording medium comes into contact with the previous recording medium.

Known is a method of shortening recording time, in a case where a width of image data is smaller than a width of a recording medium, by limiting a scan width of a recording head up to the width of the image data. With this method, setting delay time depending on the width of the recording medium makes actual scan time of the recording head shorter than scan time of the recording head for the width of the recording medium. As a result, there is a possibility that fixing time falls below necessary fixing time and smearing occurs.

### SUMMARY

According to embodiments of the present disclosure, a recording apparatus includes a recording unit configured to, in response to an instruction to record an image, apply a recording agent while performing a scan in a scan direction that intersects with a conveyance direction in which a recording medium is conveyed to record an image on the recording medium, a conveyance unit configured to convey the recording medium, a plurality of paper discharge units to which the recording medium is to be discharged, and a control unit configured to control, based on a width of recording data in the scan direction and recording scan speed of a recording scan, the recording unit to perform the scan so that time since start of the recording scan until start of a next recording scan becomes a predetermined value.

Further features of the present disclosure will become apparent from the following description of exemplary embodiments with reference to the attached drawings.

### BRIEF DESCRIPTION OF THE DRAWINGS

FIGS. 1A to 1C are perspective views each illustrating a recording apparatus according to an exemplary embodiment.

FIG. 2 is a schematic view for describing a paper feed/discharge mechanism in the recording apparatus according to the present exemplary embodiment.

FIG. 3 is a block diagram illustrating a control unit in the recording apparatus according to the present exemplary embodiment.

FIG. 4 is a schematic diagram for describing wait control between scans at the time of serial scan recording according to the present exemplary embodiment.

FIG. 5 is a table indicating a setting example regarding wait control depending on a paper discharge port according to the present exemplary embodiment.

FIGS. 6A and 6B each illustrate a setting example regarding delay time according to a conventional example.

FIGS. 7A and 7B each illustrate a setting example regarding delay time according to a first exemplary embodiment.

FIG. 8 is a flowchart for describing procedures of wait control processing according to the present exemplary embodiment.

FIGS. 9A to 9C each illustrate a setting example regarding delay time according to a second exemplary embodiment.

FIG. 10 illustrates a setting example regarding delay time according to a third exemplary embodiment.

FIGS. 11A and 11B each illustrate a setting example regarding delay time according to a fourth exemplary embodiment.

FIGS. 12A and 12B each illustrate a setting example regarding delay time according to the fourth exemplary embodiment.

FIGS. 13A to 13C each illustrate a setting example regarding delay time according to a fifth exemplary embodiment.

### DESCRIPTION OF THE EMBODIMENTS

An exemplary embodiment of the present disclosure will be described with reference to drawings. A recording apparatus according to the present exemplary embodiment is a so-called ink-jet recording apparatus that ejects ink droplets from a plurality of ejection ports each including an energy-generating element and that thereby forms dots and records an image on a recording medium.

While ink containing a coloring material is used as a recording agent in the present exemplary embodiment, the present disclosure is also applicable to a mode of using another recording agent that may cause smearing due to rubbing until the recording agent is fixed to a recording medium. In the present specification, a paper discharge method of discharging paper to a stacker, which will be described below, is hereinafter referred to as “top side discharge” and a paper discharge method of discharging paper to a basket is hereinafter referred to as “discharge to the basket”.

### (Configuration of Apparatus)

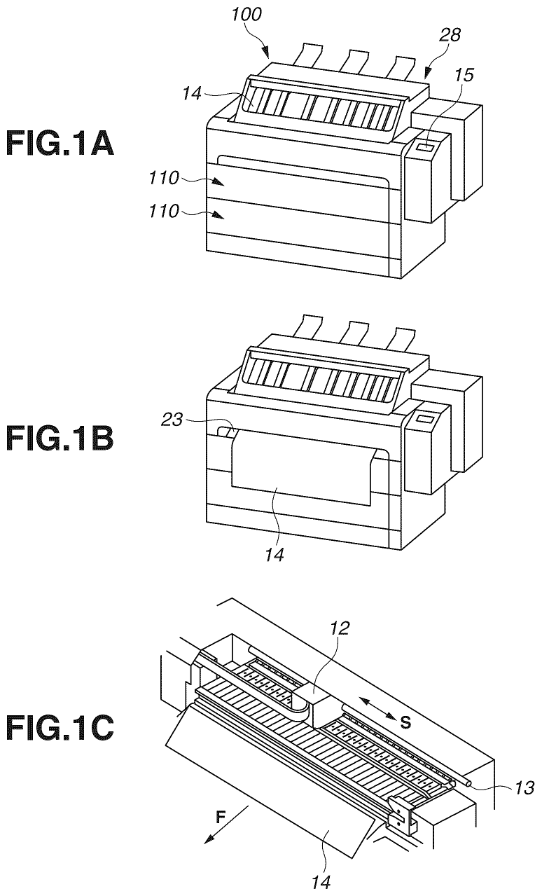

FIGS. 1A to 1C are perspective views each illustrating an ink-jet recording apparatus according to a first exemplary embodiment. FIG. 1A is a schematic perspective view illustrating a state during the top side discharge in which a recording medium is discharged to a stacker 28. It is possible to set two rolled-up recording media 14 in an ink-jet recording apparatus 100. Recording medium supply devices 110 are provided in a two-tiered manner. One of the two recording media 14 that have been set in the respective recording medium supply devices 110 is selectively drawn out. The recording medium 14 is fed and conveyed to a recording position, and a recording operation to record an image is executed.

The recording medium 14 on which the image has been recorded is discharged to the stacker 28 provided in an upper portion of the ink-jet recording apparatus 100. The stacker 28 is located above the recording position at which an image is recorded. A user uses various kinds of switches or the like provided in an operation panel 15 to input various kinds of commands and the like to the ink-jet recording apparatus 100 such as designation of a size of the recording medium 14, switching between on-line and off-line, or setting of a paper discharge destination.

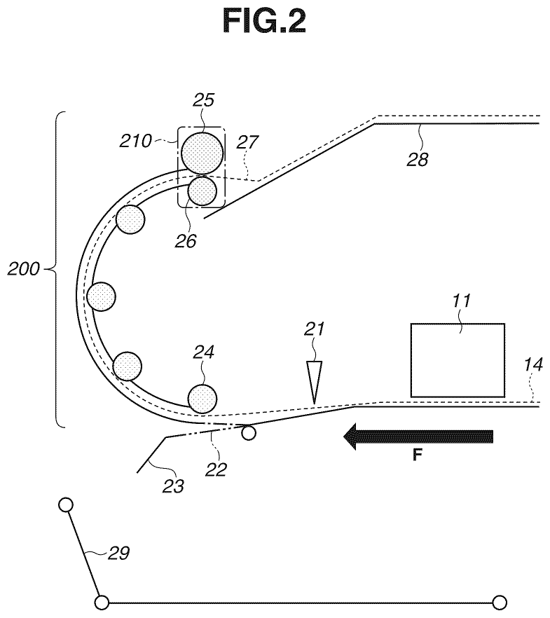

FIG. 1B is a schematic perspective view illustrating a state during the discharge to the basket in which a recording medium is discharged to a basket 29. The basket 29 is not illustrated in FIG. 1B, but is illustrated in FIG. 2, which will be described below. The recording medium 14 on which the image has been recorded passes through a basket discharge port 23 provided on a front surface portion of the ink-jet recording apparatus 100 and is discharged to the basket 29 provided in a lower portion of the ink-jet recording apparatus 100.

FIG. 1C is a perspective view for describing an internal mechanism at the recording position at which an image is recorded in the ink-jet recording apparatus 100. As illustrated in FIG. 1C, the recording medium 14 is conveyed in a conveyance direction indicated by an arrow F with driving of a sub-scan motor (not illustrated). The conveyance direction F is also referred to as a sub-scan direction. A guide shaft 13 is disposed so as to extend in a direction that intersects with the conveyance direction F of the recording medium 14. A carriage 12 on which a recording head 11 is mounted reciprocally moves in an arrow S direction (hereinafter referred to as a main scan direction) by driving of a main scan motor (not illustrated) while being supported by the guide shaft 13. The recording head 11 mounted on the carriage 12 ejects ink droplets during movement (scan) of the carriage 12 based on recording data, and forms dots on a recording medium. By the repetition of this ink ejection operation during a reciprocal scan, an image is recorded on the recording medium.

In the ink-jet recording apparatus 100 according to the present exemplary embodiment, a so-called bidirectional recording method is employed. In this method, an ink ejection operation is performed in both a case where the recording head 11 performs a scan in the main scan direction (forward direction) along a forward path and a case where the recording head 11 performs a scan in an opposite direction of the main scan direction (backward direction) along a return path. First, when a recording operation command is input by a host computer connected to the outside, the recording medium 14 is fed to a position at which recording can be performed by the recording head 11 mounted on the carriage 12. The recording head 11 then performs at least one main scan while performing an ink ejection operation in accordance with a recording signal, and the recording medium 14 is conveyed by a predetermined amount using the sub-scan motor (not illustrated). By the repetition of such a recording operation and such a conveyance operation multiple times, an image is recorded in a unit region on the recording medium.

FIG. 2 is a cross-sectional view illustrating a paper discharge mechanism in the ink-jet recording apparatus 100 according to the present exemplary embodiment. As illustrated in FIG. 2, the recording medium 14 is conveyed in the conveyance direction F by a conveyance roller (not illustrated). A cutter 21 is disposed on a downstream side of the carriage 12 in the conveyance direction F, and operates at the end of recording to cut the recording medium 14. A paper discharge switching flap 22 is disposed on a downstream side of the cutter 21, and operates in an up-and-down direction in FIG. 2. In the present exemplary embodiment, the ink-jet recording apparatus 100 is provided with the stacker 28 and the basket 29 as paper discharge units for stacking a recording medium having been conveyed. When a command for instructing a conveyance direction is input, the paper discharge switching flap 22 is set at a top side discharge postilion as indicated by a dash-dotted line in FIG. 2 in a case of the top side discharge, and is set at a discharge-to-basket position as indicated by a dash-dot-dot line in FIG. 2 in a case of the discharge to the basket. In the case of the discharge to the basket, the recording medium 14 is conveyed toward the basket discharge port 23, and discharged to the basket 29 installed in the lower portion of the ink-jet recording apparatus 100. In the case of the top side discharge, the recording medium 14 is conveyed toward a top side discharge unit 200, and discharged to the stacker 28 installed in the upper portion of the ink-jet recording apparatus 100.

In an internal mechanism of the top side discharge unit 200, a plurality of guide rollers 24 serving as conveyance assistance members is disposed so as to slide and come in contact with a recording surface of the recording medium 14 on which an image has been recorded. This configuration makes it possible to prevent a jam or the like at the time of conveyance of the recording medium 14. A paper discharge port 27 to the stacker 28 is provided with a nip portion 210 including a paper discharge roller 25 and a nip roller 26. The nip roller 26 in the nip portion 210 is urged toward the paper discharge roller 25 by predetermined force. A plurality of guide rollers 24 and a plurality of nip rollers 26 are disposed in the main scan direction in a plurality of locations inside the top side discharge unit 200. In the present exemplary embodiment, each nip roller 26 is urged with a load of approximately 200 g, but a value of the load is not limited to 200 g. In the case where the top side discharge to discharge the recording medium 14 to the stacker 28 is set in response to the command for instructing the conveyance direction, the recording medium 14 is nipped by the paper discharge roller 25 and the nip roller 26 following the completion of the recording operation. After the recording medium 14 is cut with the cutter 21, the paper discharge roller 25 is operated to convey the recording medium 14, which is then discharged to the stacker 28.

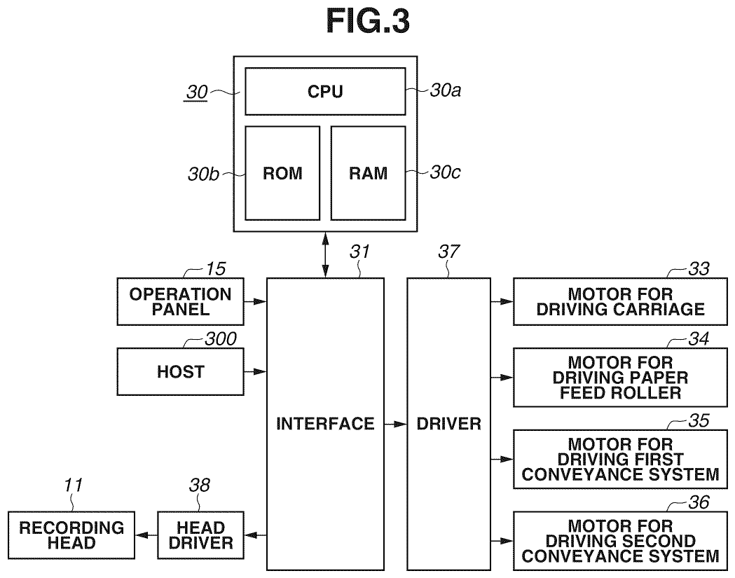

FIG. 3 is a block diagram illustrating a control unit of the ink-jet recording apparatus 100. A control system according to the present exemplary embodiment includes a control unit 30, an interface 31, the operation panel 15, a driver 37 for driving various kinds of motors, and a head driver 38 for driving the recording head 11. The control unit 30 includes a central processing unit (CPU) 30a such as a micro-processor, a read-only memory (ROM) 30b that stores a control program for the CPU 30a and various kinds of data, and a random-access memory (RAM) 30c that is used as a work area of the CPU 30a and that performs storing such as temporary storing of various kinds of data. The driver 37 performs control to drive a motor 33 for driving the carriage 12, a motor 34 for driving a paper feed roller, a motor 35 for driving a first conveyance system to be used in a top side discharge conveyance system, and a motor 36 for driving a second conveyance system to be used in a discharge-to-basket conveyance system.

The control unit 30 performs processing of inputting/outputting data such as recording data to/from a host 300 via the interface 31 and processing of inputting various kinds of information (for example, a text pitch and a text type) from the operation panel 15. The control unit 30 outputs an ON signal to drive each of the motors 33 to 36 or an OFF signal via the interface 31. The control unit 30 outputs an ejection signal or the like to the head driver 38, and controls an ink ejection operation in the recording head 11.

### (Regarding Smear)

A mechanism of occurrence of smearing due to execution of the top side discharge is now described with reference to FIG. 2. After ink is applied by the recording head 11 and an image is recorded, the recording medium 14 is conveyed in the conveyance direction F, and enters the inside of the top side discharge unit 200. At this time, if the recording medium 14 is conveyed in a state where ink applied to the recording medium 14 is not completely fixed to the recording medium 14, ink that has failed to be fixed adheres to members including the guide roller 24, the paper discharge roller 25, the nip roller 26, a wall surface inside the top side discharge unit 200, and the like. Thereafter, the recording medium 14 is further conveyed in the conveyance direction F, ink that has failed to be fixed and that has adhered to each member adheres to the recording medium 14 again, which causes an ink smudge (smear). In particular, in the case of the top side discharge, stress is concentrated at a location where the guide roller 24, the paper discharge roller 25, and the nip roller 26 are disposed and contact pressure with the recording medium 14 increases. As a result, smearing is likely to occur at the location.

In the case of the top side discharge, smearing is likely to occur as compared with the case of the discharge to the basket. Reasons for this include the following two points. The first point is that, when time after an image is recorded by the recording head 11 until the recording medium 14 reaches a corresponding paper discharge unit is compared between the top side discharge and the discharge to the basket, the time in the case of the top side discharge is overwhelmingly shorter than that in the case of the discharge to the basket. Hence, it is difficult to ensure sufficient ink fixing time at the time of the top side discharge as compared with that at the time of the discharge to the basket. The second point is that, at the time of the top side discharge, the ink-jet recording apparatus 100 is configured to convey the recording medium 14 toward the top side of the ink-jet recording apparatus 100 so as to pull the recording medium 14 up against gravitational force. Hence, stress is concentrated at the nip portion 210 and various rollers in the top side discharge unit 200, and contact force at a location at which each member and the recording medium 14 are in contact with each other increases as compared with that at the time of the discharge to the basket. As a result, smearing is likely to occur at the location. In contrast, at the time of the discharge to the basket, the recording medium 14 is discharged from the basket discharge port 23 under its own weight, and contact pressure between the basket 29 and the recording medium 14 is pressure that is equivalent to the own weight of the recording medium 14.

For the reasons described above, since the contact pressure with the recording medium 14 is high at the time of the top side discharge, there is a need for setting a stricter condition regarding an ink fixing failure than that at the time of the discharge to the basket.

Furthermore, in a case where a recording medium that has undergone recording is loaded on the stacker 28, discharge is performed while a front surface of a subsequent recording medium that has reached the paper discharge port 27 and a back surface of the loaded recording medium are rubbed against each other. This results in occurrence of smearing and image deterioration due to chafing of recording media, such as smudging of the back surface of the loaded recording medium or smudging of the recording surface of the recording medium on which recording has been performed.

To prevent the occurrence of the above-mentioned smearing, it is sufficient if certain downtime for fixing ink is adequately provided. In the present exemplary embodiment, the ink-jet recording apparatus 100 executes a delay operation of providing delay time (wait time) between recording operations to fix ink. However, because setting too long wait time decreases a throughput and productivity, it is necessary to perform minimum control to prevent smearing.

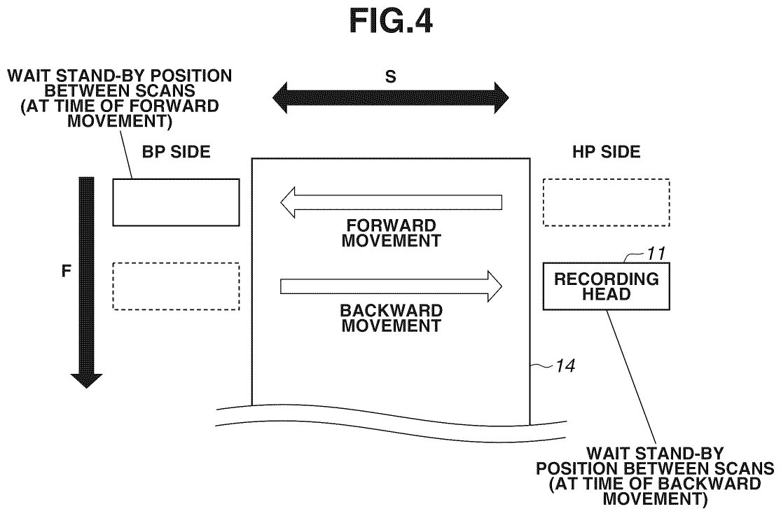

FIG. 4 is a schematic diagram for describing wait control between scans. In the wait control between scans, predetermined wait time is provided at the end of a main scan of the carriage 12 or at the time of inversion during a recording operation, and ink fixing time is thereby ensured. The ink-jet recording apparatus 100 according to the present exemplary embodiment is a so-called serial-type ink-jet recording apparatus that causes the carriage 12 to perform a scan in a direction that intersects with the conveyance direction of the recording medium 14. Specifically, the carriage 12 on which the recording head 11 is mounted performs one or multiple scans on the recording medium 14 in a main scan direction S in FIG. 4. The ink-jet recording apparatus 100 then moves the recording medium 14 in a sub-scan direction F. By the repetition of this operation, an image is recorded on the recording medium 14. The right side of FIG. 4 is referred to as a home position (HP), the left side of FIG. 4 is referred to as a back position (BP), movement of the recording head 11 from the HP to the BP is referred to be as a forward scan (forward movement), and movement of the recording head 11 from the BP to the HP is referred to be a backward scan (backward movement). Control of providing downtime between such scans is wait control between scans.

In the wait control between scans according to the present exemplary embodiment, predetermined wait time is provided only in the backward movement. Assume that a wait stand-by position of the recording head 11 at the time of the backward movement is on the HP side. The wait control between scans is not limited to such a method, and may be, for example, wait control between scans on both sides, in which downtime is provided both in the forward movement and the backward movement. The wait time between scans is time from the end of a recording scan to the start of a next recording scan.

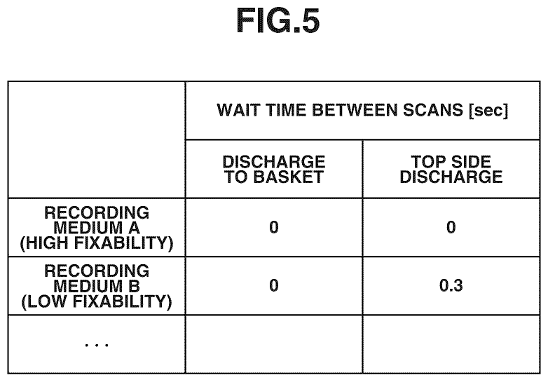

FIG. 5 is a wait control setting table in which wait time is set for each recording medium type and each paper discharge unit. A parameter for wait control between scans is set depending on setting information indicating whether a paper discharge unit is the basket 29 or the stacker 28. Since fixability of ink is different depending on a recording medium type, the downtime as the parameter for wait control is set for each recording medium type.

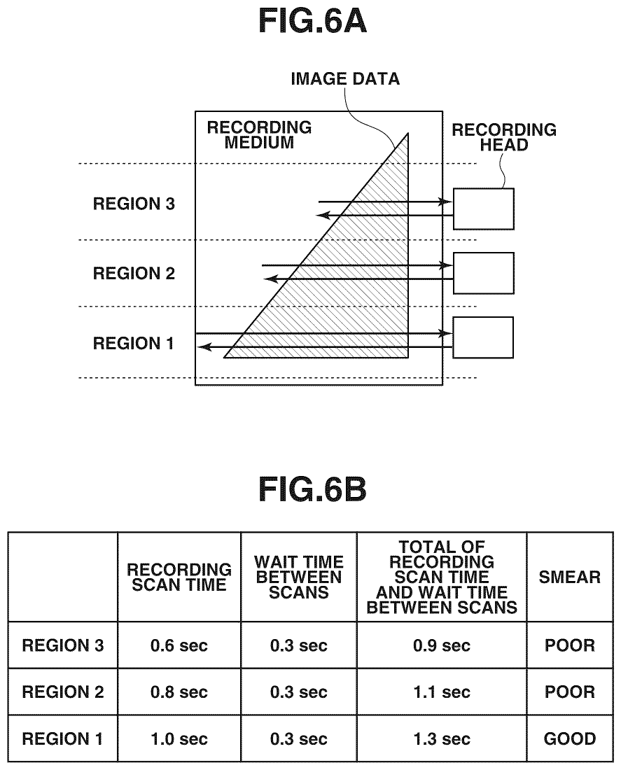

FIGS. 6A and 6B are diagrams for describing a conventional example. FIG. 6A is a diagram illustrating image data to be recorded, a recording medium, and a recording method, and illustrates an example of a recording scan in a two-path mode in which a sub-scan is not performed between a first path and a second path. FIG. 6B illustrates, in a case where recording is performed on a recording medium B with the top side discharge and waiting between scans illustrated in FIG. 5 is set according to a conventional method, recording scan time, wait time between scans, and total time of the recording scan time and the wait time between scans, and whether smearing has occurred. The total time is, in other words, time since the start of the recording scan until the start of the next recording scan.

The wait time between scans set in FIG. 5 is set on the assumption of time taken to perform a recording scan for a width of a recording medium. Hence, in a case of image data as illustrated in FIG. 6A, there is little difference between a width of a recording scan and a width of image data in a region 1, and thus total time of time taken to perform the recording scan and set wait time between scans is 1.3 seconds. This total time 1.3 seconds is set as a minimum value with which no smear occurs also in consideration of recording speed. In the region 1, the total time is equivalent to 1.3 seconds, and smearing is at a favorable level.

In contrast, widths of image data are smaller than the width of the recording medium in regions 2 and 3. As a result, time taken to perform the recording scan becomes shorter. Since the wait time between scans is uniformly set at 0.3 seconds regardless of a width of image data, a total of recording scan time and wait time between scans falls below 1.3 seconds, and levels of smearing in the regions 2 and 3 are worse than that in the region 1.

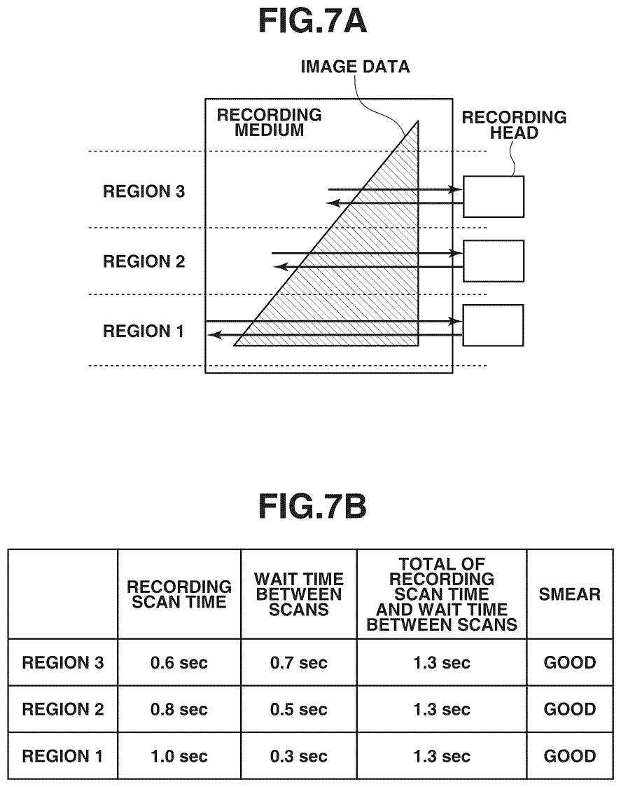

FIGS. 7A and 7B are diagrams for describing a method of setting waiting between scans according to the present exemplary embodiment in a case where the recording medium B is discharged as the top side discharge similarly to FIGS. 6A and 6B.

The present exemplary embodiment is characterized in that, as illustrated in a table in FIG. 7B, recording scan time is estimated, and wait time between scans is set so that total time of the estimated scan time and the wait time between scans is a predetermined value or more. The total time is, in other words, time since the start of the recording scan until the start of the next recording scan.

In the present exemplary embodiment, it is preliminarily understood that smearing is at a favorable level if total time of recording scan time and wait time between scans is 1.3 seconds or longer, and the wait time between scans is set so that the total time is 1.3 seconds or longer.

For example, since time taken to perform a recording scan is 0.8 seconds in the region 2, wait time between scans is set at 0.5 seconds. As a result, total time is 1.3seconds, and it can be seen that time to bring smearing into a favorable level is maintained. Similarly, since recording scan time is 0.6 seconds in the region 3, wait time between scans is set at 0.7 seconds, whereby an interval of predetermined time or longer is ensured. Needless to say, it is preferable that the set wait time between scans be minimum time in terms of productivity as long as a level of smearing satisfies a favorable standard.

It is possible to easily estimate time taken to perform the recording scan (estimated scan time) by dividing the width of image data by recording scan speed based on information regarding the recording scan speed and the width of image data. For example, in a case where the recording scan speed is 48 inches per second and the width of the recording media is 24 inches, 24/48=0.5 seconds is time taken to perform one recording scan.

Since the present exemplary embodiment employs a configuration of performing one waiting between two scans, a total of two scans in forward and backward movements and inversion time of the recording head 11 is recording scan time that should be considered. Hence, time obtained by adding the inversion time to 1 second, which is a result of doubling the time taken to perform one recording scan and obtained above, is the recording scan time that should be considered. The example in which the inversion time is not included in the recording scan time but corresponding time is reflected in the set wait time between scans has been described in the present exemplary embodiment for simplicity. However, as a matter of course, the inversion time may be included in the recording scan time, and total time of the recording scan time and the wait time between scans may be set. It is sufficient if total time spent on a target recording scan and waiting between scans can be set to be longer than or equal to time to bring smearing into a favorable level, whichever method is used.

For convenience of explanation, the description has been given of the example in which, in a case where it takes 1.0 second to perform the recording scan, the set wait time between scans is 0.3 seconds. However, to implement the present exemplary embodiment, it is sufficient if 1.3 seconds, which is total time of 1.0 second and 0.3 seconds, is stored as information in a ROM of the main body, and time obtained by subtraction of the estimated scan time is set as wait time between scans.

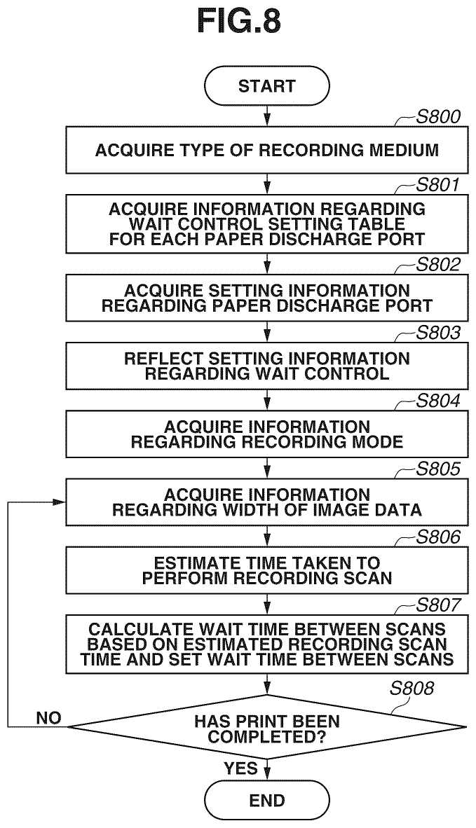

FIG. 8 is a flowchart describing wait control processing according to the present exemplary embodiment. A program for executing the present processing is preliminarily stored in the ROM 30b and executed by the control unit 30. The processing in FIG. 8 is started by reception of a recording instruction by the control unit 30.

In step S800, the control unit 30 acquires type information indicating a recording medium type. In step S801, the control unit 30 acquires wait control setting table information for each paper discharge unit illustrated in FIG. 5. The wait control setting table information may be preliminarily held as information for each recording medium type in the ROM 30b.

In step S802, the control unit 30 acquires setting information regarding a present paper discharge unit from the ROM 30b. In step S803, the control unit 30 reflects the setting information regarding wait control. In step S804, the control unit 30 acquires information regarding a recording mode from the ROM 30b. In step S805, the control unit 30 acquires information regarding a width of image data from the ROM 30b. In the present exemplary embodiment, recording modes are modes that are different in image quality and recording speed, such as a high quality mode, a standard mode, an eco-mode, or a high-speed mode. The number of print passes, a density, and the like change depending on a mode. In step S806, the control unit 30 estimates scan time taken to perform a recording scan. In step S807, the control unit 30 calculates necessary wait time between scans from the estimated scan time, notifies the driver 37 and the head driver 38 of the wait time between scans via the interface 31, and reflects the wait time between scans in a recording operation. Finally, in step S808, the control unit 30 determines whether recording has been completed. In a case where the recording has not been completed (NO in step S808), the processing returns to step S805, and the control unit 30 sets wait time between scans with respect to the next scan. In a case where the recording has been completed, that is, the scan is a final scan (YES in step S808), the processing ends.

As described above, in the present exemplary embodiment, delay time is optimally set even in a case where the width of image data is smaller than the width of the recording medium at the time of the top side discharge. As a result, it is possible to reduce smearing while preventing a decrease of a throughput.

In the first exemplary embodiment, the description has been given of the configuration of setting the wait time between scans depending on the width of image data to enable the reduction of smearing regardless of a width of data. In a second exemplary embodiment, a description will be given of a configuration of setting optimal wait time between scans depending on, in addition to the width of image data, various recording conditions. A description of a configuration similar to that in the first exemplary embodiment is omitted.

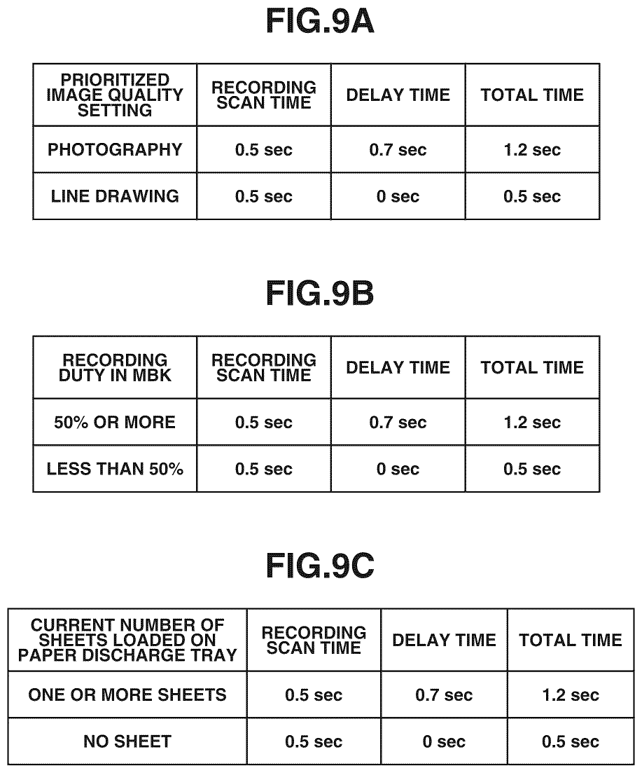

FIGS. 9A to 9C each illustrate a setting example regarding wait time between scans according to the present exemplary embodiment. FIG. 9A illustrates an example of switching a setting of delay time depending on a prioritized image quality setting set in a recording job. The prioritized image quality setting is setting of a main purpose for recording in a recording job. Assume that the prioritized image quality setting includes a “line drawing” mode on the assumption of a use application for which a lot of lines are used such as an architectural drawing, and a “photography” mode on the assumption of a use application for nature photography such as landscape photography or portrait photography and a poster to be displayed within doors or out of doors.

In the line drawing mode, it is considered that there are few regions in which a large amount of ink is used to an extent that smearing deteriorates. Thus, the line drawing mode is characterized in that an emphasis is placed on productivity in recording and delay time is set at 0 seconds. Since the photography mode is on the assumption of a region in which a large amount of ink is used to an extent that smearing deteriorates due to its use application, it is sufficient if normal wait time between scans is set similarly to the first exemplary embodiment.

FIG. 9B illustrates a specific example of setting the wait time between scans depending on a recording duty of ink that exhibits a poor level of smearing (that tends to smudge a recording surface of a recording medium) among various types of ink. Matte black (MBK) ink is ink that deteriorates smearing the most. Thus, FIG. 9B illustrates an example of setting the wait time between scans if the duty is a predetermined value or more, and not setting the wait time between scans if the duty is less than the predetermined value.

Furthermore, FIG. 9C illustrates, in the case of the top side discharge, an example of setting the wait time between scans if one or more sheets are loaded on the stacker 28 and not setting the wait time between scans if no sheet is loaded on the stacker 28. This is on the assumption of a case where smudges due to friction between pieces of paper are more noticeable than smudges on a conveyance route among the above-mentioned causes of smearing. Because friction between pieces of paper does not occur in a case where no sheet is loaded on the stacker 28, the wait time between scans is set at 0 seconds.

As described above, by setting the wait time between scans only when smearing is at a poor level and not setting the wait time between scans in other cases, it is possible to set the wait time between scans in an optimally balanced manner without sacrificing productivity while preventing smearing.

The example of not setting waiting between scans in a case where smearing is at a good level has been described for simplicity, but the configuration is not limited to the example, and it is also possible to, for example, set the wait time between scans at 0.7 seconds if smearing is at a poor level and set the wait time between scans at 0.3 seconds if smearing is at a good level. The case of setting the wait time between scans in two phases of smearing being at a good level or a poor level has been described in the present exemplary embodiment. However, needless to say, it is more preferable to make more detailed settings regarding the wait time between scans in a larger number of phases depending on a degree of actual smearing. It is preferable to appropriately set the wait time between scans by striking a balance between a set load in a parameter of wait time between scans, complications of specifications, or the like and the number of necessary phases depending on a level of smearing.

While the setting regarding delay time is implemented by waiting between scans in which delay time (wait time) is provided between recording operations in the first exemplary embodiment, an example of setting the delay time according to another method will be described. A description of a configuration similar to that in the above-mentioned exemplary embodiments is omitted.

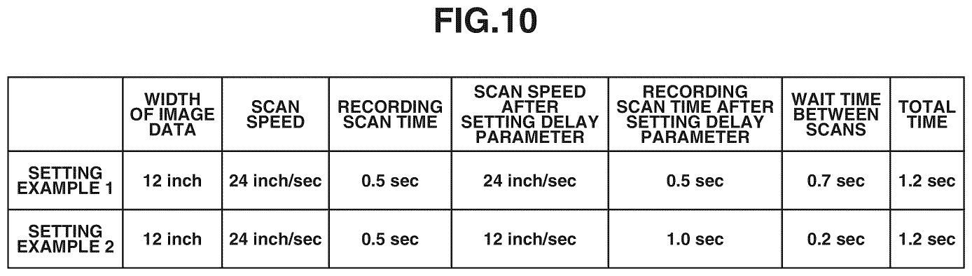

FIG. 10 illustrates a setting example of a delay parameter setting according to a third exemplary embodiment. A setting example 1 is an example of setting delay time using waiting between scans as described in the first exemplary embodiment. A setting example 2 is an example of setting delay time using a change in recording scan speed and waiting between scans. In the setting example 1, total time of recording scan time and wait time between scans is 1.2 seconds. In the setting example 2, as compared with the setting example 1, scan speed of a recording scan is changed from 24 inches per second to 12 inches per second, whereby time taken to perform the recording scan is changed from 0.5 seconds to 1.0 second. Accordingly, wait time between scans is set at 0.2 seconds. As described above, a total of recording scan time and wait time between scans is set at time similar to that in the setting example 1, whereby delay time is set so that smearing can be reduced, similarly to the setting example 1.

As an ink application amount increases, power consumption per second increases. Thus, there is a case where control to reduce power consumption is performed while scan speed of the recording scan is decreased. Even in such a case, recording scan time is estimated in consideration of changed scan speed as described in the present exemplary embodiment, whereby it is possible to appropriately set delay time that can reduce smearing and that prevents a decrease of a throughput. Needless to say, control to increase the number of print passes can also reduce power consumption and increase delay time for the same reason.

In a fourth exemplary embodiment, a description is given of setting delay time in a case where a recording scan is uniformly performed for a width of a recording medium regardless of a width of image data. A description of a configuration similar to that in the above-mentioned exemplary embodiments is omitted.

In the first exemplary embodiment, the description has been given of setting of the delay time in a case where total time of a recording scan and waiting between scans changes depending on the width of image data because the width of the recording scan is different depending on the width of image data. In the present exemplary embodiment, the width of the recording scan is uniformly set at the width of the recording medium. Thus, as an operation of the main body, processing in the present exemplary embodiment is equivalent to an operation of storing a parameter for wait time between scans for each width of the recording medium and setting the wait time between scans for each width of the recording medium. However, as described in the first exemplary embodiment, smearing can be reduced by setting total time of the recording scan and the waiting between scans at predetermined time or longer. Hence, by storing a lower limit of the above-mentioned total time of the recording scan and the waiting between scans as a threshold, rather than storing a large number of respective delay time settings for widths of recording media, it is possible to reduce smearing regardless of a width of a recording medium. Hence, as compared with the conventional example, the present exemplary embodiment has an advantage in enabling a reduction of a storage area.

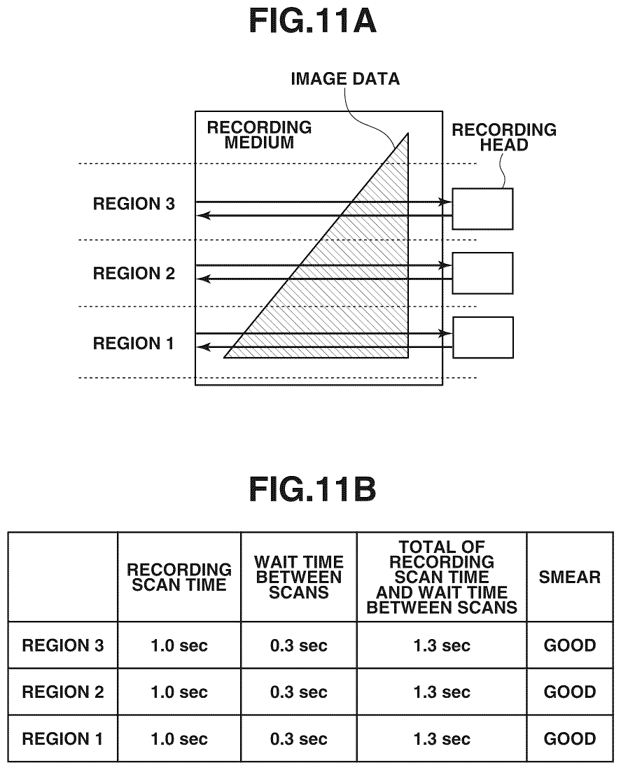

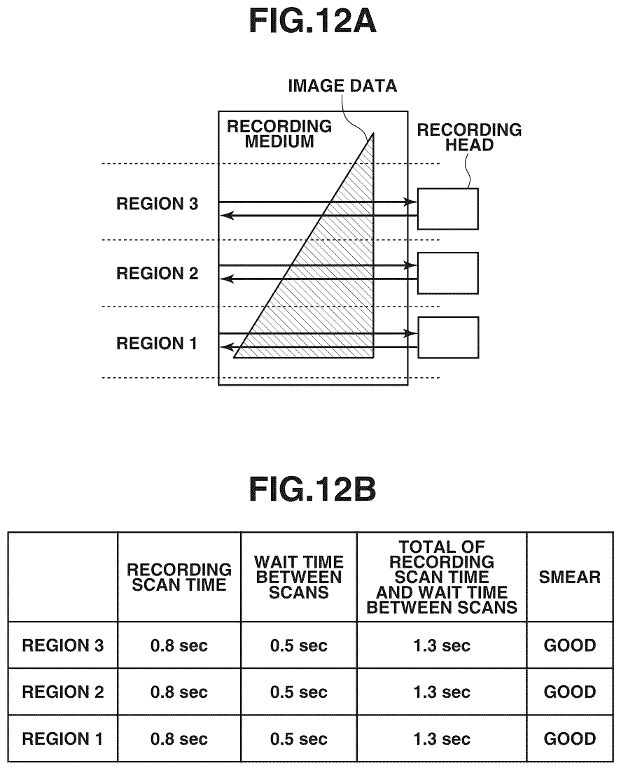

FIGS. 11A, 11B, 12A, and 12B illustrate setting examples regarding wait time between scans in a case where a scan is uniformly performed for the width of the recording scan with respect to two types of widths of different recording media. In FIGS. 11A and 11B, it takes 1.0 second to perform a recording scan, and wait time between scans is set at 0.3 seconds. As a result, total time is 1.3 seconds. This is an example that this total time is longer than or equal to time to bring smearing into a favorable level. In FIGS. 12A and 12B, since the width of the recording medium is smaller than that in FIGS. 11A and 11B, time taken to perform a recording scan is 0.8 seconds. However, by setting the wait time between scans at 0.5 seconds, it can be seen that it is possible to set a total of the recording scan time and the wait time between scans at 1.3 seconds, which is equal to that in the example in FIGS. 11A and 11B. In this manner, even in a case where the recording scan is uniformly performed for the width of the recording medium, if a way of thinking to make a total of the recording scan time and the wait time between scans a predetermined value or more is employed, smearing can be reduced as appropriate and a memory can be saved as compared with a case where respective thresholds for widths of recording media are stored.

In a fifth exemplary embodiment, an example of setting longer delay time regarding a part that is more susceptible to smearing in the configuration regarding the top side discharge described with reference to FIG. 2. A description of a configuration similar to that in the above-mentioned exemplary embodiments is omitted.

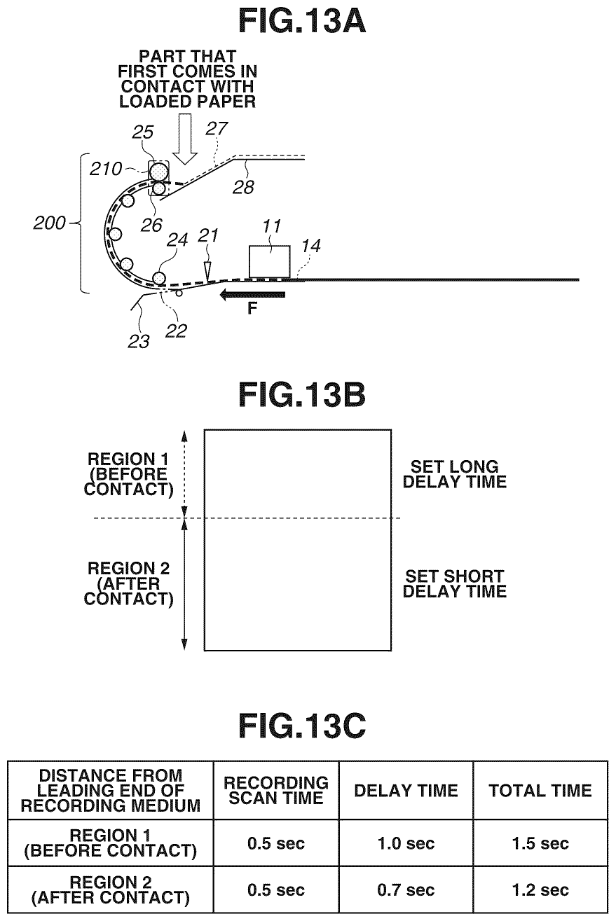

As illustrated in FIG. 13A, since a leading end portion of paper that first comes in contact with loaded paper is at a steeper angle at the time of contact than an angle of a portion subsequent to the leading end portion, a level of smearing is relatively higher. Hence, the present exemplary embodiment is characterized in setting longer delay time in a region 1 before the leading end of paper comes in contact with loaded paper. The region 1 is indicated by a broken line in FIGS. 13A and 13B. As illustrated in FIG. 13C, delay time of 1.0 second in the region 1 is set longer than 0.7 seconds in a region 2 after the leading end comes in contact with the loaded paper. The configuration naturally lengthens time since recording is ended until the paper reaches the loaded paper, and can thereby reduce smearing. After the leading end of paper comes in contact with the loaded paper, the contact angle becomes gentler as the paper during recording is discharged and thus a level of smearing also becomes relatively lower. Hence, since delay time shorter than that in the region 1 is sufficient in the region 2, shorter delay time is set in terms of a throughput.

As described above, by differentiating delay time between the region before the leading end of paper comes in contact with the loaded paper and the region after the leading end of paper comes in contact with the loaded paper, it is possible to set optimal delay time for each region. As a result, it is possible to prevent smearing while minimizing a decrease of a throughput.

In addition to the above-mentioned exemplary embodiments, delay time may be changed depending on a temperature and a humidity when recording is performed. For example, since ink is easily fixed at a high temperature, it is possible to shorten delay time. Since ink is easily fixed at a low humidity, it is possible to shorten delay time.

With the above-mentioned configurations, it is possible to prevent occurrence of smearing in recording.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-105403, filed Jun. 28, 2024, which is hereby incorporated by reference herein in its entirety.

What is claimed is:

1. A recording apparatus comprising:
a recording unit configured to, in response to an instruction to record an image, apply a recording agent while performing a scan in a scan direction that intersects with a conveyance direction in which a recording medium is conveyed to record an image on the recording medium;
a conveyance unit configured to convey the recording medium;
a plurality of paper discharge units to which the recording medium is to be discharged; and
a control unit configured to control, based on a width of recording data in the scan direction and recording scan speed of a recording scan, the recording unit to perform the scan so that time since start of the recording scan until start of a next recording scan becomes a predetermined value.

2. A recording apparatus comprising:
a recording unit configured to, in response to an instruction to record an image, apply a recording agent while performing a scan in a scan direction that intersects with a conveyance direction in which a recording medium is conveyed to record an image on the recording medium;
a conveyance unit configured to convey the recording medium;
a plurality of paper discharge units to which the recording medium is to be discharged; and
a control unit configured to control, based on a width of the recording medium and recording scan speed of a recording scan, the recording unit to perform the recording scan for the width of the recording medium regardless of a width of recording data,
wherein the control unit is configured to control the recording unit to perform, in recording of the image, the scan so that time since start of the recording scan until start of a next recording scan becomes a predetermined value.

3. The recording apparatus according to claim 1, wherein the control unit is configured to control, based on estimated scan time obtained by estimation of time taken to perform the recording scan of the recording data from the width of the recording data in the scan direction and the recording scan speed of the recording scan, the recording unit to perform the scan so that the time since the start of the recording scan until the start of the next recording scan becomes the predetermined value.

4. The recording apparatus according to claim 3, further comprising a setting unit configured to set, based on the estimated scan time, a delay operation parameter regarding an image recording operation to be performed by the recording unit so that the time since the start of the recording scan until the start of the next recording scan becomes the predetermined value,
wherein the recording unit is configured to perform the scan in accordance with the delay operation parameter set by the setting unit.

5. The recording apparatus according to claim 4, wherein the setting unit is configured to set the delay operation parameter regarding the image recording operation to be performed by the recording unit so that the time since the start of the recording scan until the start of the next recording scan becomes the predetermined value based on information indicating, out of the plurality of paper discharge units, a paper discharge unit to which the recording medium on which the image has been recorded in response to the instruction is to be discharged and the estimated scan time.

6. The recording apparatus according to claim 5, wherein, in a case where no recording medium is loaded on the paper discharge unit, delay time is not set.

7. The recording apparatus according to claim 4, wherein the delay operation parameter is delay time provided after end of the recording scan.

8. The recording apparatus according to claim 4, wherein the delay operation parameter is scan speed at time of the recording scan.

9. The recording apparatus according to claim 4, wherein the delay operation parameter is a number of print passes at time of the recording scan.

10. The recording apparatus according to claim 4, wherein the delay operation parameter is a combination of delay time provided after end of the recording scan, scan speed at time of the recording scan, and a number of print passes at time of the recording scan.

11. The recording apparatus according to claim 1, wherein delay time is set to be shorter as an ink application amount in the scan becomes smaller.

12. The recording apparatus according to claim 1, wherein delay time is set to be longer as an ink application amount of ink that tends to smudge a recording surface of the recording medium becomes larger.

13. The recording apparatus according to claim 1, wherein, in a case where a purpose of recording set in a recording job is line drawing, delay time is set to be shorter than delay time set in a case where the purpose of recording set in the recording job is photography.

14. The recording apparatus according to claim 1, wherein delay time is changed depending on a temperature and a humidity when recording is performed.

15. The recording apparatus according to claim 1, wherein delay time until a leading end of the recording medium comes in contact with a loaded recording medium is set to be longer than delay time after the leading end of the recording medium comes in contact with the loaded recording medium.

16. A recording method for a recording apparatus, the recording apparatus including a recording unit configured to, in response to an instruction to record an image, apply a recording agent while performing a scan in a scan direction that intersects with a conveyance direction in which a recording medium is conveyed to record an image on the recording medium, a conveyance unit configured to convey the recording medium, and a plurality of paper discharge units to which the recording medium is to be discharged, the recording method comprising:
performing recording to cause, based on a width of recording data in the scan direction and recording scan speed of a recording scan, the recording unit to perform an image recording operation so that time since start of the recording scan until start of a next recording scan becomes a predetermined value; and
performing discharge to discharge the recording medium that has undergone the recording.

17. A non-transitory computer-readable storage medium storing a program including executable instructions, which when executed by one or more processors of a recording apparatus including a recording unit configured to, in response to an instruction to record an image, apply a recording agent while performing a scan in a scan direction that intersects with a conveyance direction in which a recording medium is conveyed to record an image on the recording medium, a conveyance unit configured to convey the recording medium, and a plurality of paper discharge units to which the recording medium is to be discharged, cause the recording apparatus to:
perform recording to cause, based on a width of recording data in the scan direction and recording scan speed of a recording scan, the recording unit to perform an image recording operation so that time since start of the recording scan until start of a next recording scan becomes a predetermined value; and
perform discharge to discharge the recording medium that has undergone the recording.
